(19) United States
(12) Patent Application Publication
(10) Pub. No.: US 2008/0094679 A1
(43) Pub. Date: Apr. 24, 2008

(54) Light source module and scanning module using the same

(75) Inventors: Yu-Lang Wang, Jhubei City (TW); Min Chieh Chiang, Zihguan Township (TW); Chia-Shin Lin, Hsinchu City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/907,491

(22) Filed: Oct. 12, 2007

(30) Foreign Application Priority Data
Oct. 19, 2006 (TW) 095138499

(51) Int. Cl. G02B 26/08; F21S 4/00; F21V 7/04

(52) U.S. Cl. 359/212; 362/217; 362/555

(57) ABSTRACT

A light source module includes a base, a cold cathode fluorescent lamp (CCFL) and an auxiliary light emitting unit. The CCFL disposed on the base provides main light. The auxiliary light emitting unit disposed on the base includes a plurality of light emitting diodes (LEDs) respectively disposed adjacent to two ends of the CCFL. The auxiliary light emitting unit provides auxiliary light to compensate for the main light, wherein the light source module emits scanning light, which is substantially uniformly distributed along a length of the CCFL.

### BACKGROUND OF THE INVENTION

1. Field of Invention

The invention relates to a light source module and a scanning module using the same, and more particularly to a light source module including a cold cathode fluorescent lamp (CCFL) and light emitting diodes (LEDs), and a scanning module using the light source module.

2. Related Art

A light source used in a conventional scanner is mainly a cold cathode fluorescent lamp (CCFL). The CCFL advantageously has the high luminance, but disadvantageously has the longer warm-up time and the nonuniform luminance. More particularly, the luminance at each of two ends of the CCFL is lower than that at the middle section so that the scanned quality is influenced. Thus, the prior art decreases the luminance at the middle section of the lamp using a light-absorbing material, uses a double-U type lamp to homogenize the luminance of the linear light outputted from the lamp, or uses software or firmware to correct the scanned image.

However, the double-U type lamp cannot be easily manufactured and has the relatively high manufacturing cost. In addition, lowering the luminance at the middle section of the lamp makes the luminance insufficient, and the luminance of the lamp has to be inevitably increased so that the lifetime of the lamp is inevitably shortened. In addition, using the software or firmware to correct the image needs very complicated computations, and even cannot obtain the satisfactory corrected result when the luminance difference on the lamp is very obvious.

Thus, it is an important object of the invention to provide a light source module capable of outputting uniform light.

### SUMMARY OF THE INVENTION

It is therefore an object of the invention to provide a light source module and a scanning module using the light source module and thus to solve the problem of the non-uniformity of luminance of a cold cathode fluorescent lamp (CCFL).

To achieve the above-identified object, the invention provides a light source module including a base, a cold cathode fluorescent lamp (CCFL) and an auxiliary light emitting unit. The CCFL disposed on the base is for providing main light. The auxiliary light emitting unit disposed on the base provides auxiliary light to compensate for the main light, and the auxiliary light emitting unit includes a plurality of light emitting diodes (LEDs) disposed adjacent to two ends of the CCFL. The light source module outputs scanning light, which is substantially uniformly distributed along a length of the CCFL.

The invention also provides a scanning module for scanning a document. The scanning module includes a base, at least one reflecting mirror, a lens, an image sensor and a light source module. The at least one reflecting mirror, the lens and the image sensor are mounted on the base. The light source module mounted on the base includes a CCFL and an auxiliary light emitting unit. The CCFL disposed on the base provides main light. The auxiliary light emitting unit disposed on the base provides auxiliary light to compensate for the main light. The auxiliary light emitting unit includes a plurality of light emitting diodes (LEDs) disposed adjacent to two ends of the CCFL. The light source module emits scanning light which is substantially uniformly distributed along a length of the CCFL. The scanning light is projected to the document and is reflected by the document and the at least one reflecting mirror successively before the scanning light is received by the image sensor through the lens.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a pictorial view showing a scanning module according to a first embodiment of the invention;

FIG. 2 is a schematic illustration showing the scanning module according to the first embodiment of the invention;

FIG. 3 is a schematic top view showing a light source module according to the first embodiment of the invention;

FIG. 4 is a schematic top view showing a light source module according to a second embodiment of the invention; and

FIG. 5 is a schematic top view showing a light source module according to a third embodiment of the invention.

### DETAILED DESCRIPTION OF THE INVENTION

The present invention will be apparent from the following detailed description, which proceeds with reference to the accompanying drawings, wherein the same references relate to the same elements.

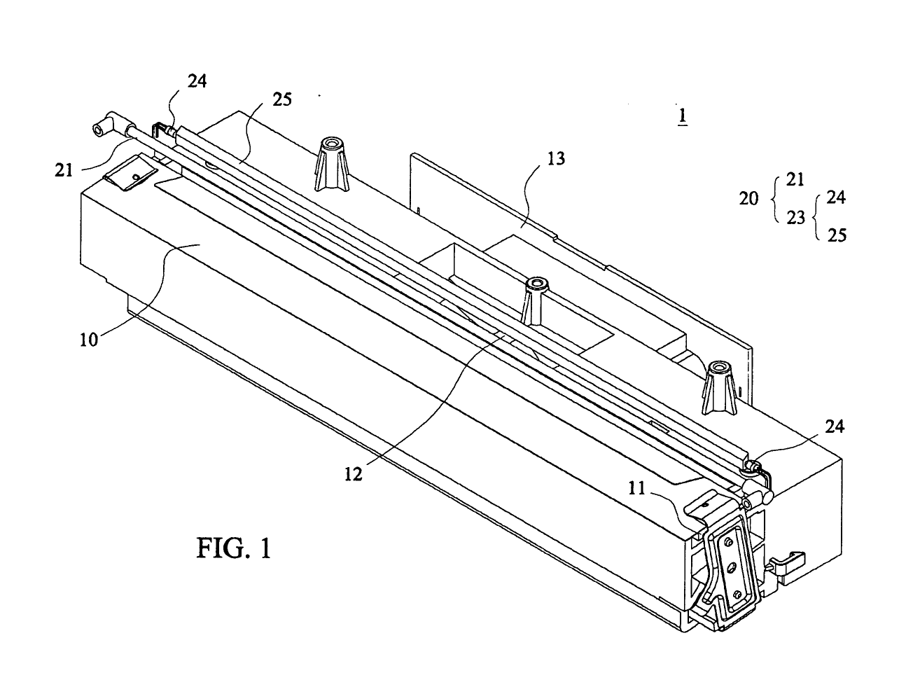

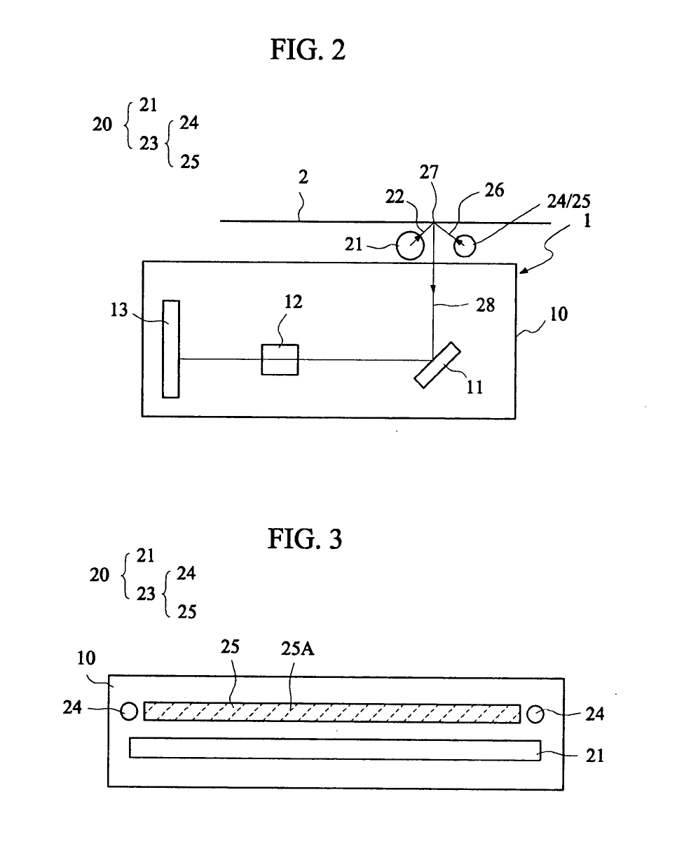

FIG. 1 is a pictorial view showing a scanning module 1 according to a first embodiment of the invention. FIG. 2 is a schematic illustration showing the scanning module 1 according to the first embodiment of the invention. As shown in FIGS. 1 and 2, the scanning module 1 for scanning a document 2 includes a base 10, at least one reflecting mirror 11, a lens 12, an image sensor 13 and a light source module 20.

The reflecting mirror 11, the lens 12 and the image sensor 13 are mounted on the base 10. The light source module 20 mounted on the base 10 includes a cold cathode fluorescent lamp (CCFL) 21 and an auxiliary light emitting unit 23. The CCFL 21 disposed on the base 10 is for providing main light 22. The auxiliary light emitting unit 23 disposed on the base 10 includes a plurality of light emitting diodes (LEDs) 24 disposed adjacent to two ends of the CCFL 21, that is, the auxiliary light emitting unit 23 may include two LEDs 24, each of which is disposed adjacent to one end of the CCFL 21. The LEDs 24 may be aligned to provide linear light directly or through a light-guiding rod.

The auxiliary light emitting unit 23 provides auxiliary light 26 to compensate for the main light 22 so that the light source module 20 may output scanning light 27, which is substantially uniformly distributed along a length of the CCFL 21. The auxiliary light emitting unit 23 may further include a light-guiding rod 25, which is disposed substantially in parallel to the CCFL 21 and receives and processes the light of the LEDs 24 to generate the auxiliary light 26.

The scanning light 27 is projected to the document 2 and is reflected by the document and the reflecting mirror 11 successively before the scanning light (reflected scanning light 28) is received by the image sensor 13 through the lens 12.

FIG. 3 is a schematic top view showing a light source module according to the first embodiment of the invention. Referring to FIG. 3, the light source module 20 of this embodiment includes the base 10, the CCFL 21 and the auxiliary light emitting unit 23. A surface of the light-guiding rod 25 of the auxiliary light emitting unit 23 is made of reflective materials 25A, which may be such that the luminance at each of two ends of the light-guiding rod 25 is greater than that at the middle section of the light-guiding rod 25. Thus, the insufficient luminance at each end of the CCFL may be compensated.

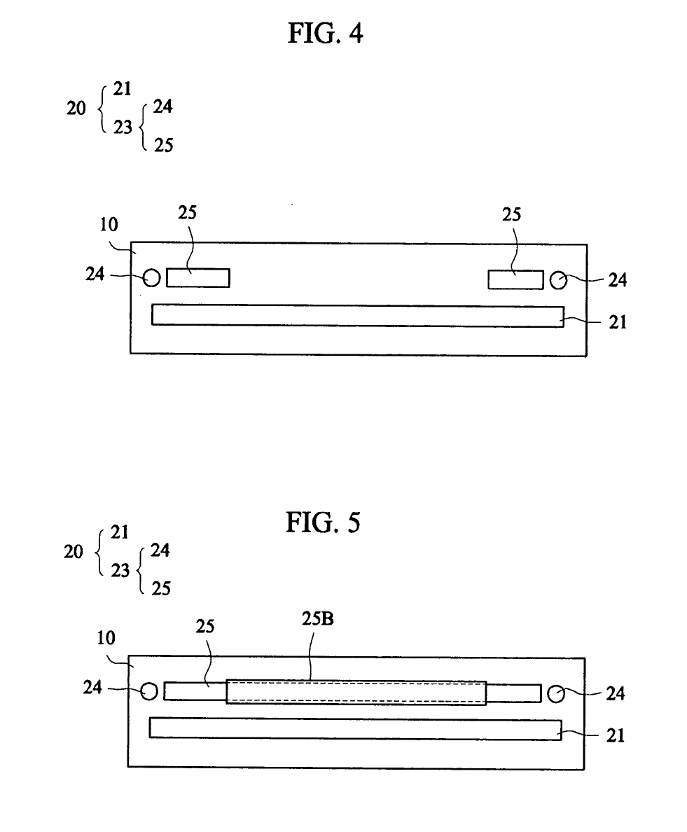

FIG. 4 is a schematic top view showing a light source module according to a second embodiment of the invention. As shown in FIG. 4, the auxiliary light emitting unit 23 further includes two light-guiding rods 25, which are disposed substantially in parallel to the CCFL 21. The light-guiding rods 25 receive and process the light of the LEDs 24 to generate the auxiliary light 26 (see FIG. 2) and thus to compensate for the insufficient luminance at two ends of the CCFL.

FIG. 5 is a schematic top view showing a light source module according to a third embodiment of the invention. As shown in FIG. 5, a light-shielding element 25B covers a middle section of the light-guiding rod 25 so as to compensate for the insufficient luminance at two ends of the CCFL. Also, the light-guiding rod 25 may be partially covered by a light-shielding element 25B.

According to the embodiments of the invention, it is possible to solve the problem of the nonuniform luminance in the scanning module using the light source module with the CCFL effectively. Thus, the light with the uniform and slightly increased luminance may be provided to illuminate the document so that the better scan quality may be obtained.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A light source module, comprising:
a base;
a cold cathode fluorescent lamp (CCFL), disposed on the base, for providing main light; and
an auxiliary light emitting unit, disposed on the base, for providing auxiliary light to compensate for the main light, wherein the auxiliary light emitting unit comprises a plurality of light emitting diodes (LEDs) disposed adjacent to two ends of the CCFL,
wherein the light source module outputs scanning light, which is substantially uniformly distributed along a length of the CCFL.

2. The light source module according to claim 1, wherein the auxiliary light emitting unit further comprises:
a light-guiding rod, disposed substantially in parallel to the CCFL, for receiving and processing light of the LEDs to generate the auxiliary light.

3. The light source module according to claim 2, wherein a surface of the light-guiding rod is made of reflective materials.

4. The light source module according to claim 2, wherein the light-guiding rod is partially covered by a light-shielding element.

5. The light source module according to claim 4, wherein a middle section of the light-guiding rod is covered by the light-shielding element.

6. The light source module according to claim 1, wherein the auxiliary light emitting unit further comprises:
two light-guiding rods, disposed substantially in parallel to the CCFL, for receiving and processing light of the LEDs to generate the auxiliary light.

7. A scanning module for scanning a document, the scanning module comprising:
a base;
at least one reflecting mirror, a lens and an image sensor, all of which are mounted on the base; and
a light source module mounted on the base, the light source module comprising:
a cold cathode fluorescent lamp (CCFL), disposed on the base, for providing main light; and
an auxiliary light emitting unit, disposed on the base, for providing auxiliary light to compensate for the main light, wherein the auxiliary light emitting unit comprises a plurality of light emitting diodes (LEDs) disposed adjacent to two ends of the CCFL,
wherein the light source module emits scanning light which is substantially uniformly distributed along a length of the CCFL,
wherein the scanning light is projected to the document and is reflected by the document and the at least one reflecting mirror successively before the scanning light is received by the image sensor through the lens.

8. The scanning module according to claim 7, wherein the auxiliary light emitting unit further comprises:
a light-guiding rod, disposed substantially in parallel to the CCFL, for receiving and processing light of the LEDs to generate the auxiliary light.

9. The scanning module according to claim 8, wherein a surface of the light-guiding rod is made of reflective materials.

10. The scanning module according to claim 8, wherein the light-guiding rod is partially covered by a light-shielding element.

11. The scanning module according to claim 10, wherein a middle section of the light-guiding rod is covered by the light-shielding element.

12. The scanning module according to claim 7, wherein the auxiliary light emitting unit further comprises:
two light-guiding rods, disposed substantially in parallel to the CCFL, for receiving and processing light of the LEDs to generate the auxiliary light.
